(19) United States
(12) Patent Application Publication
(10) Pub. No.: US 2014/0085414 A1
(43) Pub. Date: Mar. 27, 2014

(54) ENHANCING CONTENT VIEWING EXPERIENCE

(71) Applicants: Xiaoming Zhou, Eindhoven (NL); Mirela Alina Albu, Boukoul (NL)

(72) Inventors: Xiaoming Zhou, Eindhoven (NL); Mirela Alina Albu, Boukoul (NL)

(21) Appl. No.: 13/807,701

(22) PCT Filed: Jun. 22, 2011
(86) PCT No.: PCT/IB11/52732

§ 371 Date: Oct. 3, 2013

(30) Foreign Application Priority Data
Jun. 28, 2010 (EP) 10167444.8

(51) Int. Cl. H04N 13/00; G06F 3/01; G06T 7/20

(52) U.S. Cl. CPC H04N 13/0007; G06T 7/2086; G06F 3/016
USPC 348/43

(57) ABSTRACT

A system and method are proposed for enabling personal tactual or haptic feedbacks based on the motion direction of one or more objects in a scene of viewing content. Content analysis technology is used to calculate the motion direction of each object on a display. Furthermore, the actuators along the directions (600) of the object(s) are triggered to provide appropriate haptic feedback.

### FIELD OF THE INVENTION

The invention relates to a system and a method for enhancing a content viewing experience.

### BACKGROUND OF THE INVENTION

With rapid developments in computing power, digital multimedia and immersive displays, viewers are currently able to enjoy and be immersed in high quality audio-visual media. Especially in the area of broadcast displays, technological advances have been aimed at providing viewers with a more immersive experience that blurs the traditional boundary between reality and displayed scenes, supporting the impression of ‘being there’, or presence. For instance, wide-screen displays adopting high-definition (HD) video offer a wide field of view for preventing the viewers from being disturbed by the real environment, and three-dimensional television (3D-TV) supports a natural viewing experience such that viewers are able to perceive objects in true dimensions and natural colours. Additionally, 3D sound systems provide directional audio, further helping to increase the sense of presence in the viewing scene.

Recently, also the use of providing tactual feedback by using haptic technology has been envisaged. WO 2009/136345 discloses a method for conveying an emotion to a person being exposed to multimedia information, such as a media clip, by way of tactile stimulation using a plurality of actuators arranged in a close vicinity of the person's body. The method comprises the step of providing tactile stimulation information for controlling the plurality of actuators, wherein the plurality of actuators are adapted to stimulate multiple body sites in a body region. The tactile stimulation information comprises a sequence of tactile stimulation patterns, and each tactile stimulation pattern controls the plurality of actuators in time and space to enable the tactile stimulation of the body region. The tactile stimulation information is synchronized with the media clip. As a result, emotions can be induced, or strengthened, at the right time, i.e. synchronized with a specific situation in the media clip.

### SUMMARY OF INVENTION

It is an object of the invention to provide a system and a method, which go a step further in making the content viewing experience more immersive.

To better address this concern, according to a first aspect of the invention, a system is provided for enhancing a content viewing experience comprising a tactual feedback provider for providing tactual (haptic) feedback on the basis of a motion direction of at least a moving object in video of the content and/or on the basis of a motion direction of audio in an audio track of the content.

As a result, the viewer(s) may be provided with a proper personal haptic feedback (i.e., the sense of touch) adapting to the (movie) scene. This can better make the watching experience more immersive.

According to an embodiment the system further comprises a motion direction determiner for determining the motion direction of the at least one moving object by means of content analysis. Thereto existing products or algorithms may be used. The motion direction of the at least one moving object may be determined by analysing the video or by analysing the audio track.

The content viewing experience is particularly immersive in case that the video is 3D video and/or the audio track is 3D or surround audio.

According to a further embodiment, the tactual feedback provider is configured for moving the tactual feedback in substantially the same direction as the motion direction of the at least one moving object and/or the audio. By matching the direction of the tactual feedback to the direction of the moving object and/or audio, the viewer is provided with an appropriate haptic effect. Such proper personal haptic effects greatly improve a (3D) TV experience.

According to a still further embodiment, the tactual feedback provider is configured to mimic a tactual effect caused by the at least one moving object. For example, in case of an explosion of the moving object, the tactual feedback may be vibration. Again, the viewer is provided with a a proper haptic effect.

The tactual feedback provider may comprise a plurality of actuators for providing force feedback. The tactual feedback provider may consist of one or more haptic devices, such as gloves, cushions on a sofa, a mat etc. Such devices are well adapted for use in a home or cinema viewing environment. They should be made easy to use, put on or to wear for the viewer.

The devices each may have multiple embedded vibration motors. They can be made to vibrate based on a trigger event provided by the system.

According to a yet further embodiment, multiple micro heaters are embedded along the vibration motors. By using thermal feedback in addition to tactual feedback, a still more immersive viewing experience can be provided.

According to a second aspect of the invention a method is provided of enhancing a content viewing experience comprising the step of providing tactual feedback on the basis of a motion direction of at least a moving object in video of the content and/or on the basis of a motion direction of audio in an audio track of the content.

These and other aspects of the invention will be apparent from and elucidated with reference to the embodiments described hereinafter.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 is a block diagram of a system according to an embodiment of the invention;

FIG. 2 shows the estimation of a motion direction according to an embodiment of the invention.

FIG. 3 shows examples of devices for providing tactual feedback according to an embodiment of the invention.

FIG. 4 shows a mat comprising an array of vibration motors according to an embodiment of the invention.

FIG. 5 shows the mat according to FIG. 4, wherein micro heaters are co-located to the vibration motors.

FIG. 6-8 show an embodiment according to the invention wherein the vibration motors of a mat are triggered, which are linked to a motion direction.

FIG. 9-12 show a further embodiment according to the invention wherein the vibration motors of a mat are triggered, so as to mimic the motion of a moving object.

FIG. 13-14 show tactual feedback based on a 3D audio effect.

FIG. 15-16 show multiple tactual feedback effects provided on a single mat.

FIG. 17 shows giving a proper personal tactual feedback.

### Throughout the figures like reference numerals refer to like elements.

### DETAILED DESCRIPTION OF EMBODIMENTS

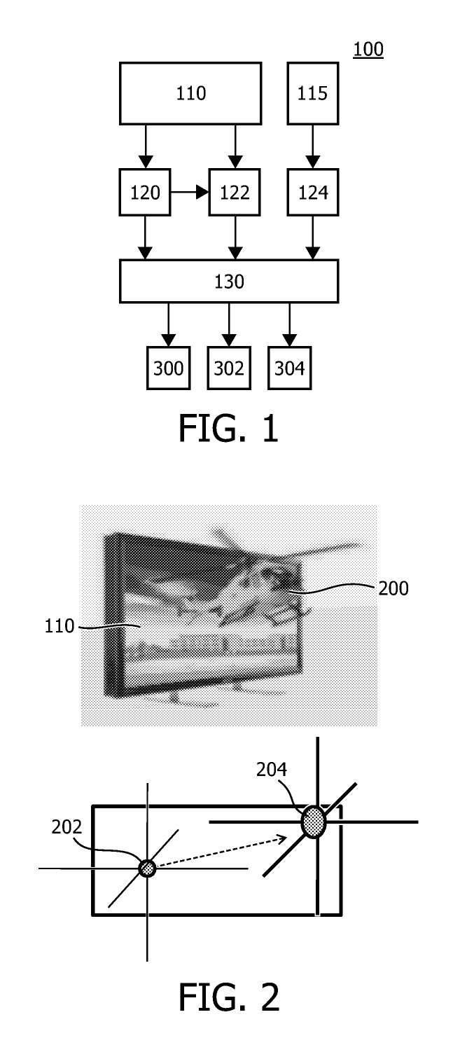

FIG. 1 is a block diagram of an exemplary system 100 according to the invention. The system comprises an apparatus for rendering a 3D viewing content. The content comprises 3D video rendered by device 110 and an audio track of 3D or surround audio provided by loudspeakers 115. Devices for providing 3D viewing content are well known, for example from the papers P. Seuntiëns, I. Vogels, and A. van Keersop, “Visual experience of 3D-TV with pixelated ambilight,” in Proceedings of PRESENCE 2007, 2007 and R. G. Kaptein, A. Kuijsters, M. T. M. Lambooij, W. A. IJsselsteijn, and I. Heynderickx, “Performance evaluation of 3D-TV systems,” in Image Quality and System Performance V, S. P. Farnand and F. Gaykema, Eds., vol. 6808 of Proceedings of SPIE, pp. 1-11, San Jose, Calif., USA, January 2008.

The system comprises functionality 120 to determine what object is displayed on the 3D TV. Such functionality is well known in the art, it may for example use commercially available content analysis technology. Furthermore, the system comprises functionality 122 to estimate the motion direction of each moving object (e.g. a fight plane or a launched missile) in real time. Also this functionality is as such well known in the art. As shown in FIG. 2, there are multiple observation points 202, 204 of each flying object, and from the multiple observation points' geometric coordinates, it is possible to estimate the motion direction of an object. Additionally, the system comprises functionality 124 to determine the direction of audio. Such functionality is known from e.g. the following papers:

Aid Härmä, Steven van de Par, Werner de Bruijn (2007) Spatial audio rendering using sparse and distributed arrays In: AES 122nd Convention Vienna, Austria,

Aid Härmä, Steven van de Par, Werner de Bruijn (2008) On the use of directional speakers to create a sound source close to the listener In: AES 124th Convention Amsterdam, The Netherlands,

Timo Haapsaari, Werner De Bruijn, Aid Härmä (2007) Comparison of Different Sound Capture and Reproduction Techniques in a Virtual Acoustic Window In: AES 122nd Convention Vienna, Austria, and

F. Hamidi, and B. Kapralos. “A review of spatial sound for virtual environments and games with graphics processing units”. The Open Virtual Reality Journal. 2009

The audio may be related (caused) by a moving object, such as the sound caused by a moving motor bike. It may however also be unrelated to any moving objects, for example in case of an explosion.

A controller 130 determines based on what object is displayed on the 3D TV, and the motion direction thereof and/or the motion direction of the 3D audio, the proper tactual feedback or haptic effect (i.e. the sense of touch). In this description the terms “tactual” and “haptic” are used as synonyms, they relate to the same concept.

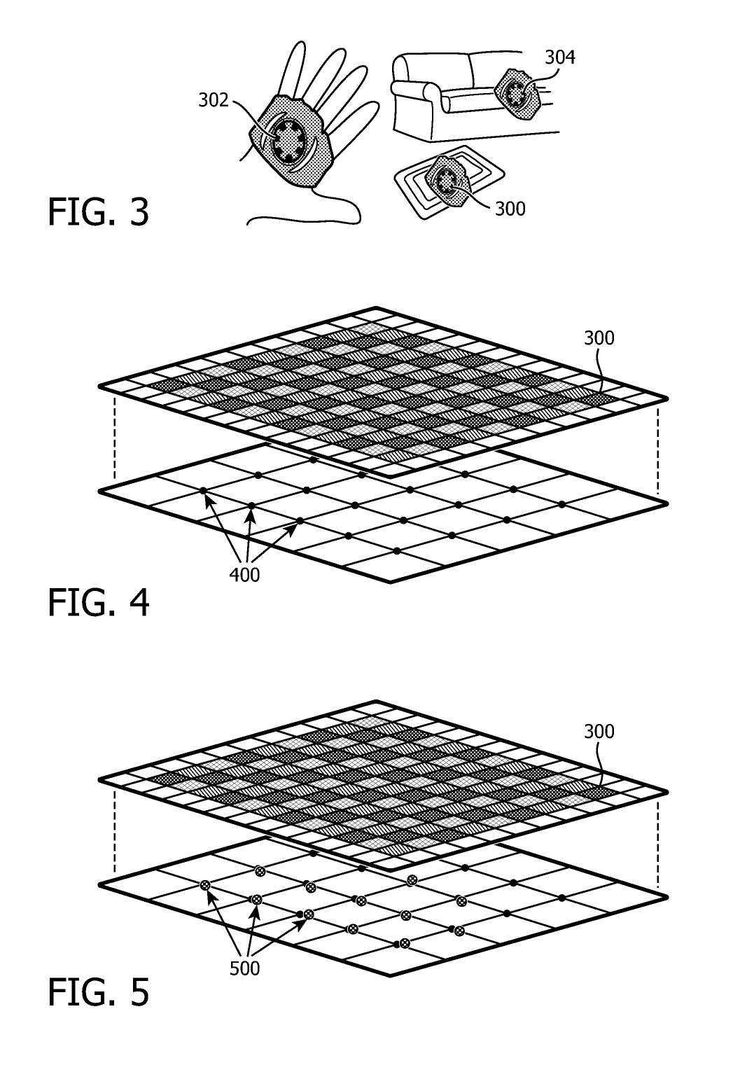

The controller wirelessly transmits control signals (commands) to a tactual feedback provider, which comprises several devices 300, 302, 304. As shown in FIG. 3, these devices may be a mat, a glove, a cushion on a sofa, etc. The devices are easy to use, put on or wear. Each haptic device uses haptic actuators to provide haptic sensations (force feedback) to a user. Each of the devices may have multiple embedded vibration motors.

FIG. 4 shows an example of a haptic (tactual) feedback device that may be used in the system. It is a mat 300 wherein many micro vibration motors 400 are embedded to provide haptic feedbacks. The micro motors vibrate based on a command from the controller 130. It is possible to design and program different haptic patterns. For example, in the first 10 milliseconds, the most left motor vibrates, then for the second 10 milliseconds, the motor on its right vibrates, and so on. In addition to the tactual feedback, a thermal feedback may be given. A possible implementation is to embed multiple micro heaters 500 along the vibration motors 400 as shown in FIG. 5.

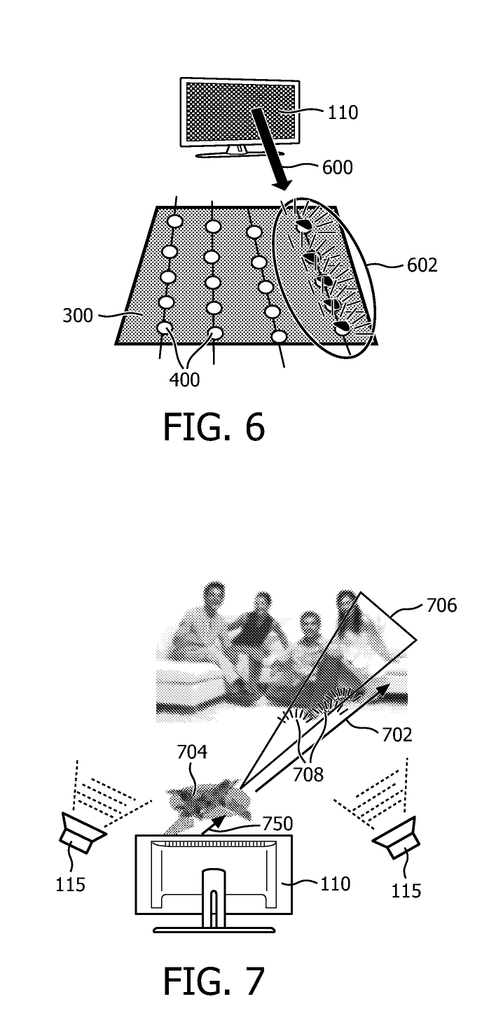

Now with reference to FIGS. 6-8 an exemplary system concept will be explained. When there is only a moving object being displayed, the following procedures would be run as shown in FIG. 6. In order to work properly, the haptic device (mat in this case) should be positioned in a certain way with respect to the rendering device.

In one variant, users register the haptic devices by e.g., using a user interface to notify the system of their presence. Then the system then may teach users via a user interface how to properly place the mat, cushion, and glove in a certain way with respect to the rendering device. In another embodiment, the haptic devices are provided with a portable device with a transponder, and the digital television set automatically recognizes their presence. The detected haptic devices' positions in the TV system need not very accurate to link the motors in a mat to the motion direction.

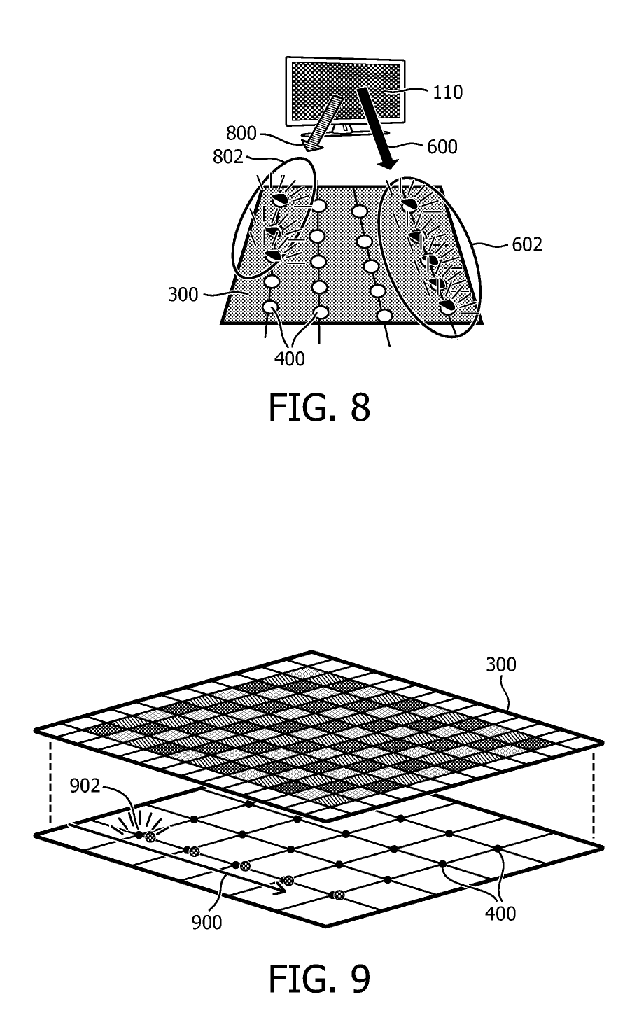

First, the system estimates the motion direction 600 of the moving object. Then, the system detects which motors in the mat are linked to that motion direction. A possible way is to predefine some motors in an area 602 linked to a possible direction . For example, when a motion direction of an object is detected to be the right, some motors linked to right setting are triggered. FIG. 7 shows a similar scenario from a different perspective. The motion direction 700 of the object 704 is substantially parallel to the haptic direction 702 and the motors 708 within a surface 706 along the haptic direction are triggered to vibrate. In this way, personal effects are provided to the users. Of course the same approach can be applied to a multiple-object scenario. FIG. 8 depicts the secnario in case of a second moving object moving in direction 800, causing the triggering of the motors in an area 802 linked to the direction 800 are triggered to vibrate.

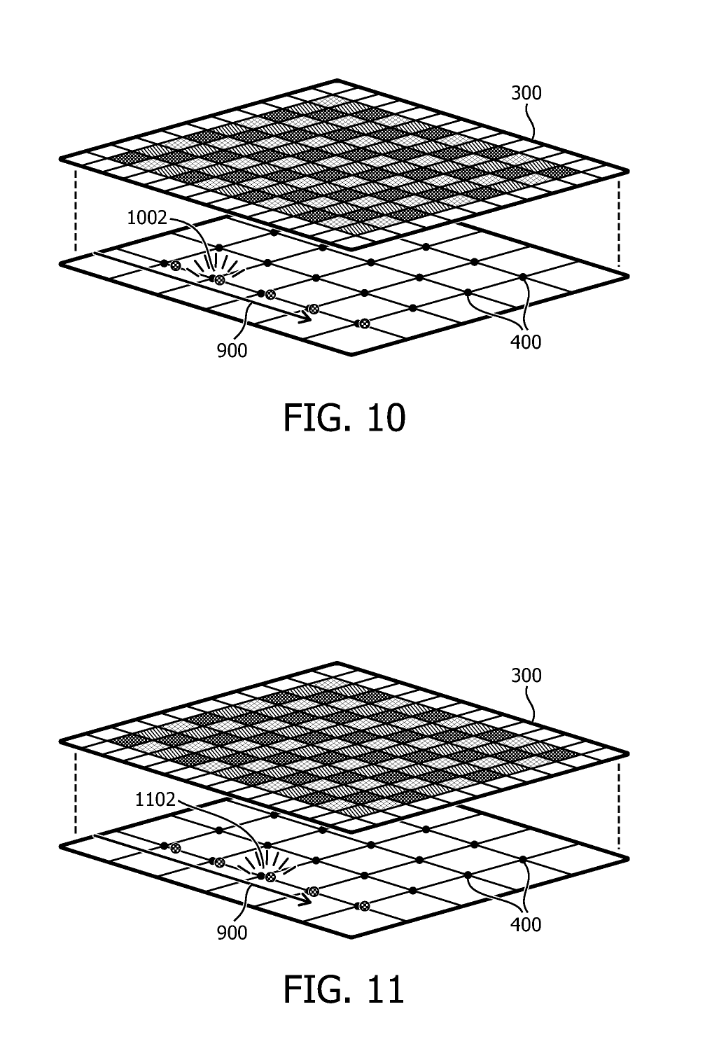

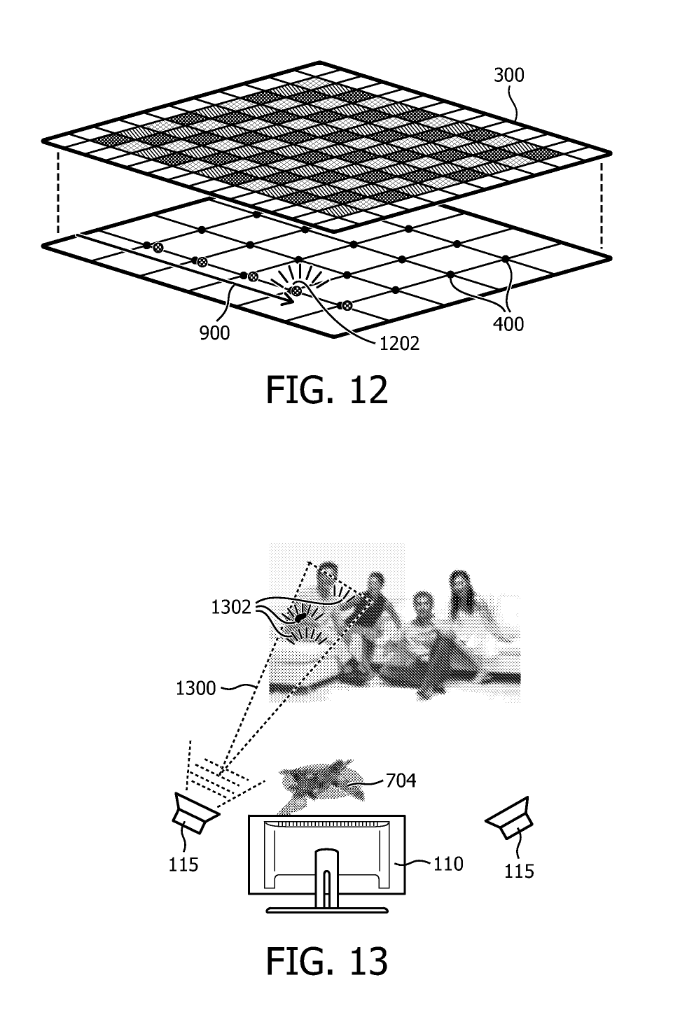

It is also possible to design and apply some haptic patterns to mimic the motion of the objects. An example thereof is shown in FIGS. 9-12. When a motion direction 900 is detected from the left to the right, the vibration motors are triggered in a left-to-right order ((902)->(1002)->(1102)->(1202)) to extend the motion from the 3D TV display to the living room.

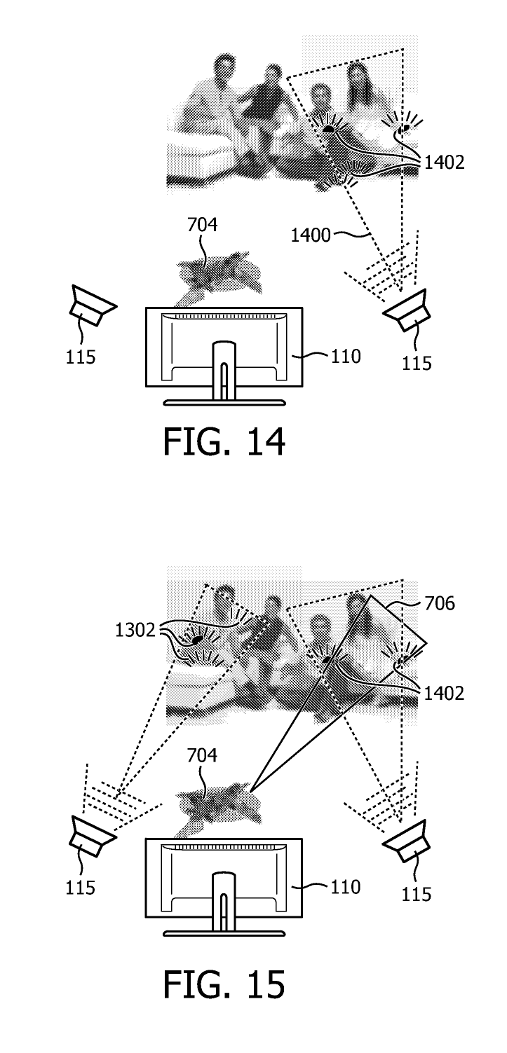

It is also possible to provide haptic feedbacks based on 3D audio effect. FIGS. 13-14 illustrates an exemplary system concept for this purpose. possible product concept described by this invention. As the direction of the sound beams 1300,1400 played out by the speakers 115 can be controlled, the controller 130 comprises the necessary information to determine the direction thereof The same approach described herein above with reference to FIGS. 6-8 is used to trigger the personal haptic effects. So, the motors 1302, 1402 in the areas of the sound beams are triggered to vibrate.

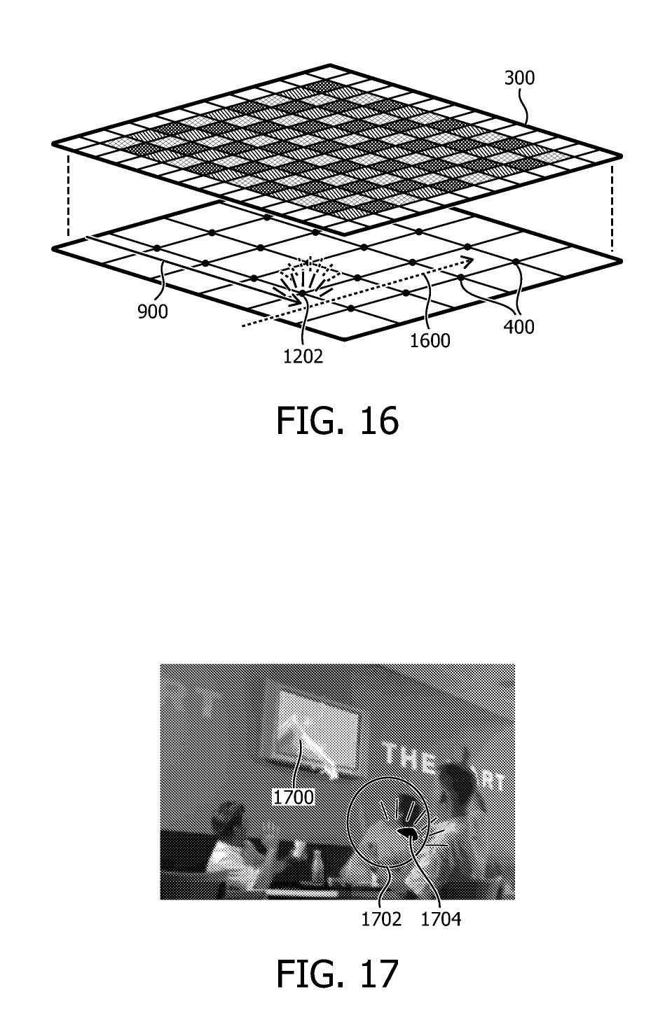

FIGS. 15-16 show haptic feedback based on both 3D video and 3D audio effects. The respective haptic effects may be triggered on the same mat. FIG. 16 shows the situation that the video direction 900 and the audio direction 1600 are substantially perpendicular and the motors are triggered subsequently along each one of these directions. FIG. 16 shows that motor 1202 is triggered, because according to both feedback algorithms, the one following the vodeo direction and the one folloiwng the audio direction, it is its turn to be triggered.

FIG. 17 shows a further example of using the system 100. only user 1702 is “spread” by the falling milk 1700, for example, he gets a haptic effect 1704, as others sitting on a safer place.

The mapping between the mat and the 3D objects and their trajectories may be performed by the following steps:

Divide both the TV screen and the mat in equal numbers of quadrants.

Use object tracking over multiple frames to identify an object in the video.

Use 3D depth map to determine whether the object is moving towards the users or away from them.

If the object is moving towards the users, identify over a number of frames the x and y coordinates of the object to find out from which quadrant of the screen the object departs and under which angle it arrives to which end quadrant on the screen.

Render haptic effect on the quadrant of the blanket that corresponds with the end quadrant where the object arrives on the TV screen.

In this way the users can establish the analogy with the object in the sense that an object coming out of the screen hits them where they would expect. For example, if a ball comes out of the screen and falls down towards the left side of the TV screen then the corresponding bottom side of the mat in the correct quadrant will render a haptic effect.

It should be noted that the above-mentioned embodiments illustrate rather than limit the invention, and that those skilled in the art will be able to design many alternative embodiments without departing from the scope of the appended claims. The mere fact that certain measures are recited in mutually different dependent claims does not indicate that a combination of these measures cannot be used to advantage. The word ‘comprising’ does not exclude the presence of other elements or steps than those listed, and the word ‘a’ or ‘an’ preceding an element does not exclude the presence of a plurality of such elements. Any reference signs do not limit the scope of the claims. The invention may be implemented by means of both hardware and software, and several elements may be represented by the same item of hardware or software, and a processor may fulfill the function of one or more elements, possibly in cooperation with hardware elements.

1. System (100) for enhancing a content viewing experience comprising:
means (122,124) for determining a motion direction on the basis of a motion direction of at least one moving object (704) in video of the content and/or on the basis of a motion direction of audio in an audio track of the content;
a tactual feedback provider (300,302,304) for providing tactual feedback on the basis of the motion direction determined by the means (122,124) for determining the motion direction

2. The system according to claim 1 further comprising a motion direction determiner (122,124) for determining the motion direction of the at least one moving object by means of content analysis.

3. The system according to claim 2, wherein the motion direction determiner is configured for determining the motion direction of the at least one moving object in the video and/or by determining the motion direction of the at least one moving object in the audio track.

4. The system according to claim 1, wherein the video is 3D video and/or the audio track is 3D or surround audio.

5. The system according to claim 1, wherein the tactual feedback provider is configured for moving the tactual feedback in substantially the same direction as the motion direction (900) of the at least one moving object and/or the audio.

6. The system according to claim 1, wherein the tactual feedback provider is configured to mimic a tactual effect caused by the at least one moving object.

7. The system according to claim 1, wherein the tactual feedback provider comprises a plurality of actuators (400) for providing force feedback.

8. The system according to claim 7, wherein the tactual feedback provider comprises one or more devices each having multiple embedded vibration motors.

9. The system according to claim 8, wherein in multiple micro heaters (500) are embedded along the vibration motors.

10. The system according to claim 1, wherein the tactual feedback provider is configured for providing also thermal feedback.

11. A method of enhancing a content viewing experience comprising the steps of
determining a motion direction on the basis of a motion direction of at least a moving object in video of the content and/or on the basis of a motion direction of audio in an audio track of the content;
providing tactual feedback on the basis of a the motion direction determined in said determining step.

12. The method according to claim 11, wherein the motion direction of the at least one moving object is determined by using content analysis, by determining the motion direction of the at least one moving object in the video and/or by determining the motion direction of the at least one moving object in the audio track.

13. The method according to claim 11, wherein the video is 3D video and/or the audio track is 3D or surround audio.

14. The method according to claim 11, wherein the tactual feedback moves in substantially the same direction as the motion direction of the at least one moving object and/or the audio.

15. The method according to claim 11, wherein the tactual feedback mimics a tactual effect caused by the at least one moving object.
